(19) United States
(12) Patent Application Publication
(10) Pub. No.: US 2013/0294434 A1
(43) Pub. Date: Nov. 7, 2013

(54) METHOD FOR CONNECTIONLESS MESSAGING, MACHINE-READABLE STORAGE MEDIUM, AND COMMUNICATION TERMINAL

(71) Applicant: SAMSUNG ELECTRONICS CO., LTD., Gyeonggi-do (KR)

(72) Inventor: Sung-Jin LEE, Gyeonggi-do (KR)

(73) Assignee: Samsung Electronics Co., Ltd., Gyeonggi-do (KR)

(21) Appl. No.: 13/888,792

(22) Filed: May 7, 2013

(30) Foreign Application Priority Data
May 7, 2012 (KR) 10-2012-0048077

(51) Int. Cl. H04W 76/02

(52) U.S. Cl. CPC H04W 76/023
USPC 370/338

(57) ABSTRACT

A method for connectionless messaging, a machine-readable storage medium, and a communication terminal are provided. A method for connectionless messaging between a first communication terminal and a second communication terminal includes: discovering a second communication terminal located in proximity to the first communication terminal; receiving first user input data; generating a message including the first user input data; and transmitting the generated message to the second communication terminal without a connection between the first communication terminal and the second communication terminal.

### PRIORITY

This application claims priority under 35 U.S.C. §119(a) to Korean Patent Application Serial No. 10-2012-0048077, which was filed in the Korean Intellectual Property Office on May 7, 2012, the contents of which are incorporated herein by reference.

### BACKGROUND OF THE INVENTION

1. Field of the Invention

The present invention relates generally to a method for exchanging messages between communication terminals, and more particularly, to an apparatus and a method for connectionless messaging.

2. Description of the Related Art

Wireless Fidelity (Wi-Fi) Direct (WFD) is a communication technology that goes beyond the limit of an existing wireless Local Area Network (LAN) technology in which a network is formed with an Access Point (AP) as its center, and that enables devices to directly connect to each other without the AP and exchange data.

A basic connection scheme used in (WFD) is a scheme for connecting two devices in one-to-one correspondence and forming a (WFD) network. For example, a smart phone may be directly connected to another smart phone via (WFD), a laptop computer may be directly connected to a mouse via (WFD), or a tablet PC may be directly connected to a printer via (WFD), and thereby, an Internet connection may be established and a network formed. Also, it is possible to form a network between a first device and one or more second devices, such as a digital camera, an MP3 player, a video game console and a TV, which are located around the first device. Accordingly, the (WFD) technology can be used for the purpose of easily transmitting a photograph, music or a moving image, which is stored in a smart phone, to another smart phone, or immediately printing a document and a photograph which are stored in a tablet PC, or synchronizing contacts between a PC and a smart phone, or directly connecting video game consoles and enjoying a video game by competing with each other. The wireless LAN technology, as described above, is presently adopted and installed in vehicles. However, the wireless LAN technology is commonly used for setting up a connection between devices within a vehicle.

As described above, the (WFD) scheme is a scheme for making a direct connection between devices without an AP. Accordingly, any one device of two or more devices forming a group in the (WFD) network must operate as a group owner which has control over other devices and has the right to influence them.

In conventional processes, a group owner must be designated and a connection is set up through a process for mutual request and acceptance.

In the scenario in which the devices intended to form a (WFD) network and perform services as described above, any one device of the devices is designated as a group owner and performs an AP function. An Internet Protocol (IP) connection is made between the devices based on performance of the AP function by the group owner. An IP application service is performed based on the IP connection and the devices can exchange messages with each other.

However, in the case of communication between vehicles, the prior art as described above is not appropriate for the following reasons.

In most cases, most vehicles meet once and usually do not meet again. Despite this fact, it unlikely that a vehicle, which is operating or stops on a road, recognizes another vehicle located around it, which is also operating or stops, and performs a process in which the vehicle sends a request for a connection to the other vehicle and the other vehicle accepts the request.

In view of the characteristics of an environment of a user who is driving a vehicle, the exchange of messages between vehicles has a main purpose, which is not a complex service such as IP-based messaging, but rather a simple communication. Accordingly, the exchange of messages between vehicles does not have to use the IP-based messaging described above.

Presently, messaging services used in smart phones perform messaging communications based on a friends list which is managed through a process for registering a friend based on an address book or an identifier, which is input by a user, and accepting the registration of the friend. However, this scheme is inappropriate for an environment in which messages are exchanged between vehicles on the road.

### SUMMARY OF THE INVENTION

The present invention has been made to address at least the above-mentioned problems and/or disadvantages related to the prior art and to provide at least the advantages described below. Accordingly, aspects of the present invention provide a messaging method which does not separately require a connection setup, provide a scheme for connectionless messaging which is different from a scheme for exchanging messages between previously-registered users, and can be used even in a vehicle environment.

In accordance with an aspect of the present invention, a method for connectionless messaging between a first communication terminal and a second communication terminal is provided. The method includes discovering the second communication terminal located in proximity to the first communication terminal; receiving first user input data; generating a message including the first user input data; and transmitting the generated message to the second communication terminal without a connection between the first communication terminal and the second communication terminal.

In accordance with another aspect of the present invention, a method for connectionless messaging between a first communication terminal and a second communication terminal is provided. The method includes discovering the second communication terminal located in proximity to the first communication terminal; receiving a message from the second communication terminal without a connection between the first communication terminal and the second communication terminal; identifying whether the received message is a peer-to-peer (P2P) message including first user input data of the second communication terminal; and reporting the first user input data of the second communication terminal to a user of the first communication terminal when the received message is the P2P message.

In accordance with still another aspect of the present invention, a machine-readable storage medium for recording a program for executing the method for the connectionless messaging is provided.

In accordance with yet another aspect of the present invention, a communication terminal including the machine-readable storage medium is provided.

### BRIEF DESCRIPTION OF THE DRAWINGS

The above and other, aspects, features, and advantages of the present invention will be more apparent from the following detailed description taken in conjunction with the accompanying drawings, in which:

FIG. 1 is a view corresponding to a method for connectionless messaging according to an embodiment of the present invention;

FIG. 2 is a block diagram illustrating a configuration of a first communication terminal;

FIG. 3 is a signal flow diagram corresponding a communication process between a first communication terminal and a second communication terminal according to an embodiment of the present invention;

FIG. 4 is a view corresponding to a service discovery message;

FIG. 5 is a flowchart corresponding to a method for connectionless messaging by a first communication terminal according to an embodiment of the present invention;

FIG. 6 is a view illustrating a screen of a first communication terminal;

FIG. 7 is a flowchart corresponding to a method for connectionless messaging by a second communication terminal according to an embodiment of the present invention;

FIG. 8 is a view illustrating a screen of a second communication terminal; and

FIG. 9 is a signal flow diagram corresponding to a connection process between a first communication terminal and a second communication terminal.

### DETAILED DESCRIPTION OF EMBODIMENTS OF THE PRESENT INVENTION

Hereinafter, various embodiments of the present invention will be described in detail with reference to the accompanying drawings. The following description includes specific details such as elements, etc., which are only provided in order to help a more comprehensive understanding of the present invention. Therefore, it will be apparent to those having ordinary skill in the technical field of the present invention that predetermined changes in form and details can be made in the specific details without departing from the scope of the present invention. Further, when it is determined that a detailed description of the known art related to the present invention may obscure the subject matter of the present invention, the detailed description thereof will be omitted.

Hereinafter, in embodiments of the present invention, ordinal numbers such as first and second are used, but the ordinal numbers are only used to distinguish between elements having an identical name. The order of the elements can be optionally determined, and the preceding description can be applied correspondingly to an element assigned different ordinal number.

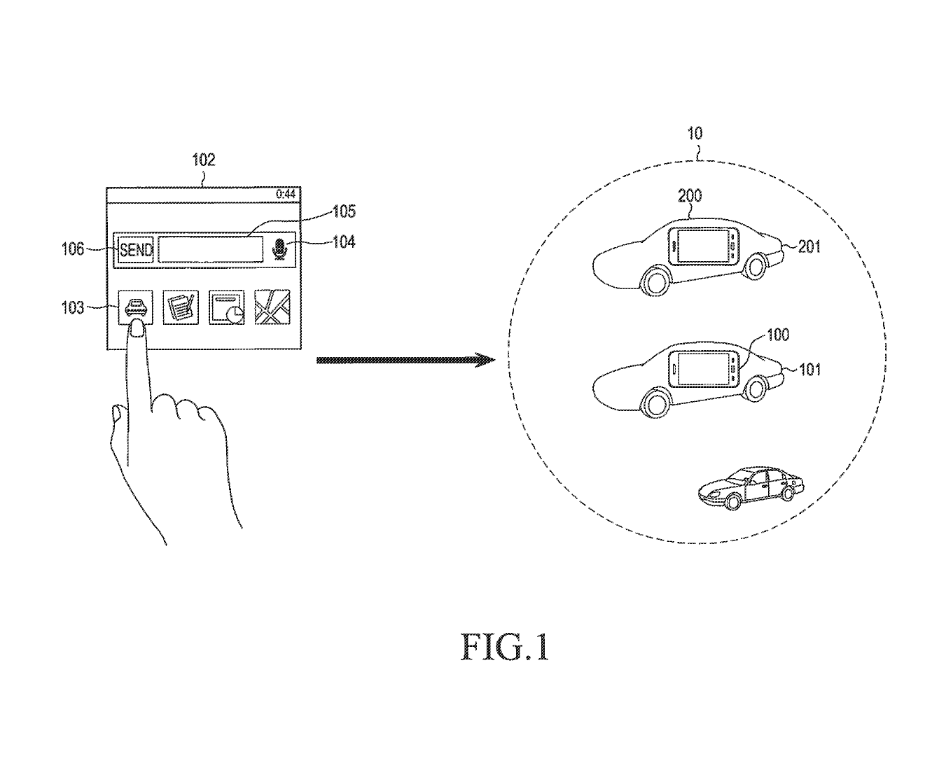

FIG. 1 is a view corresponding a method for connectionless messaging according to an embodiment of the present invention. This embodiment of the present invention relates, particularly, to an embodiment applied to communication between vehicles. However, the present invention can be applied to a connectionless messaging service between a first terminal 100 and at least one second terminal 200. The terminals may include, for example, a smart phone, a mobile phone, a digital camera, an MP3 player, a video game console, a television (TV), a display device, a head unit for a vehicle, a laptop computer, a tablet Personal Computer (PC), a Personal Media Player (PMP), a Personal Digital Assistant (PDA), a navigation device, etc.

The left portion of FIG. 1 illustrates a screen or a screen image 102 of a first communication terminal 100 mounted in a first vehicle 101 of a first user. The right portion of FIG. 1 illustrates communication between the first communication terminal 100 of the first vehicle 101 and a second communication terminal 200 of a second vehicle 201.

Referring to the left portion of FIG. 1, the first communication terminal 100 stores a connectionless messaging application 103 and a voice recognition application 104. The first communication terminal 100 displays applications (e.g., a navigation application, a memo application, etc.) such as the connectionless messaging application 103 and the voice recognition application 104, a connectionless message transmission button 106, a message input window 105, etc., on a touch screen in the form of executable icons. When a user executes the connectionless messaging application 103 through a touch or voice command, the first communication terminal 100 searches for at least one communication terminal located in an area 10 around it, and communicates with the at least one communication terminal. In the present invention, the term “connectionless communication” refers to communication achieved without a session or an IP connection, in which a process for authentication, the election of a group owner and the like is performed.

The right portion of FIG. 1 illustrates a communication process between the second communication terminal 200 and the first communication terminal 100 among other communication terminals (not shown) around the first communication terminal 100.

This embodiment assumes a scenario in which the first user of the first vehicle 101, which is travelling on a road, delivers vehicle abnormality information, information about what is ahead of the vehicle, and intention information such as a passing warning, to a user of a vehicle around the first vehicle 101.

Accordingly, although a method for connectionless messaging between the first vehicle 101 and the second vehicle 201 is described below as an example, the method may be applied similarly and repeatedly to the first vehicle 101 and another vehicle around the first vehicle 101.

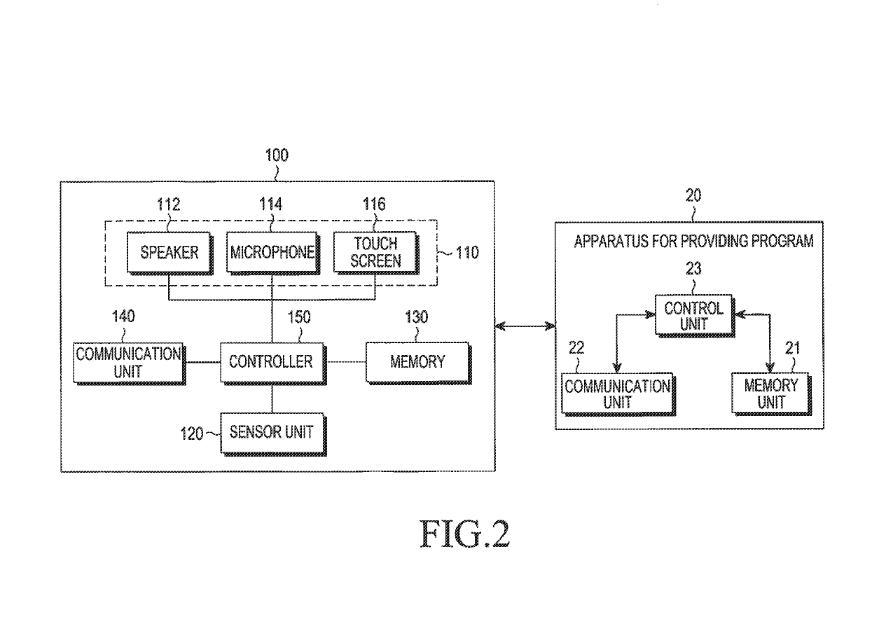

FIG. 2 is a block diagram illustrating a configuration of the first communication terminal. Each of a plurality of communication terminals around the first communication terminal 100, including the second communication terminal 200, may have a configuration identical to that of the first communication terminal 100.

The first communication terminal 100 includes a user interface 110 which includes a speaker 112, a microphone 114 and a touch screen 116, a sensor unit 120, a memory 130, a communication unit 140, and a controller 150. Also, the first communication terminal 100 may further include a keypad including multiple buttons, etc.

The speaker 112 outputs a voice signal (or voice data), which is input from the controller 150, to the outside. The microphone 114 detects a voice of a user as an electrical voice signal, and outputs the electrical voice signal to the controller 150.

The touch screen 116 displays an image based on an image signal, which is input from the controller 150, and simultaneously receives user input data and outputs the user input data to the controller 150. The touch screen 116 may include a display unit such as, for example, an LCD (Liquid Crystal Display), an OLED (Organic Light Emitting Diode), or an LED (Light Emitting Diode), and a touch panel disposed below or above the display unit. The touch panel senses user input. When a user input means (for example, a finger or a stylus) touches the surface of the touch screen, the touch panel outputs a sensing signal (or touch sensing signal) having information about an input position (or input coordinates) and/or an input state (e.g., mouse down, mouse up, mouse movement, or the like). For example, the user may touch various executable items displayed on a screen of the touch screen 116 (namely, the surface of the touch screen 116), thereby executing an application related to the item. The touch screen 116 is a means for receiving input from the user, and outputs screen images related to a connectionless messaging application.

Referring to the left portion of FIG. 1, the connectionless messaging application 103 may be executed by, for example, button input, touch input, or a voice command through the voice recognition application 104. The voice recognition application 104 may be executed automatically or by touch input from the user, and may receive input from the user. With regards to the connectionless messaging application 103, the message input window 105 is provided, and a message may be input through a text input interface or the voice recognition application 104. The message may be transmitted, for example, through the separate transmission button 106, a voice command, or based on an elapsed time period beginning from the last input time point.

The sensor unit 120 which senses the location, bearing and movement of the first communication terminal 100, includes at least one of an acceleration sensor, a gravity sensor, a shock sensor, a GPS (Global Positioning System) and a compass sensor.

The memory 130 stores map information for navigation, an operating system of the first communication terminal 100, various applications thereof, information which is input to the first communication terminal 100, information generated within the first communication terminal 100, and the like.

The communication unit 140 transmits a message or data which has been generated by the controller 150 (by wire or wirelessly) or receives a message or data (by wire or wirelessly) and outputs the received message or data to the controller 150. The communication unit 140 has a wireless LAN function supporting WFD. The wireless LAN function may be activated based on a user input, the reception of a message, and the like, or may be activated automatically. In addition, the wireless LAN function may be deactivated based on the user input, the non-reception of a message during a predetermined time period, and the like, or may be deactivated automatically. Also, the communication unit 140 may periodically transmit a beacon signal (or a message) including a device ID corresponding to unique identifier information of the first communication terminal 100.

The controller 150, which is a central processing unit, serves to control an overall operation of the first communication terminal 100, and serves to perform a method for connectionless messaging according to an embodiment of the present invention.

An apparatus 20 for providing a program includes a memory unit 21 for storing the program including instructions causing the first and second communication terminals 100 and 200 to perform the method for connectionless messaging, update information of the program, and the like. The apparatus 20 also includes a communication unit 22 for performing wired or wireless communication with the first communication terminal 100 or the second communication terminal 200. The apparatus 20 also includes a control unit 23 for transmitting the relevant program to the first communication terminal 100 or the second communication terminal 200 at a request from the first communication terminal 100 or the second communication terminal 200, or automatically.

According to an embodiment of the present invention, without performing a process for setting up a connection between the first communication terminal 100 and the second communication terminal 200, a peer-to-peer (P2P) message or a P2P Short Message Service (SMS) message, which is newly defined before a connection setting, is transmitted and/or received in a non-connection state.

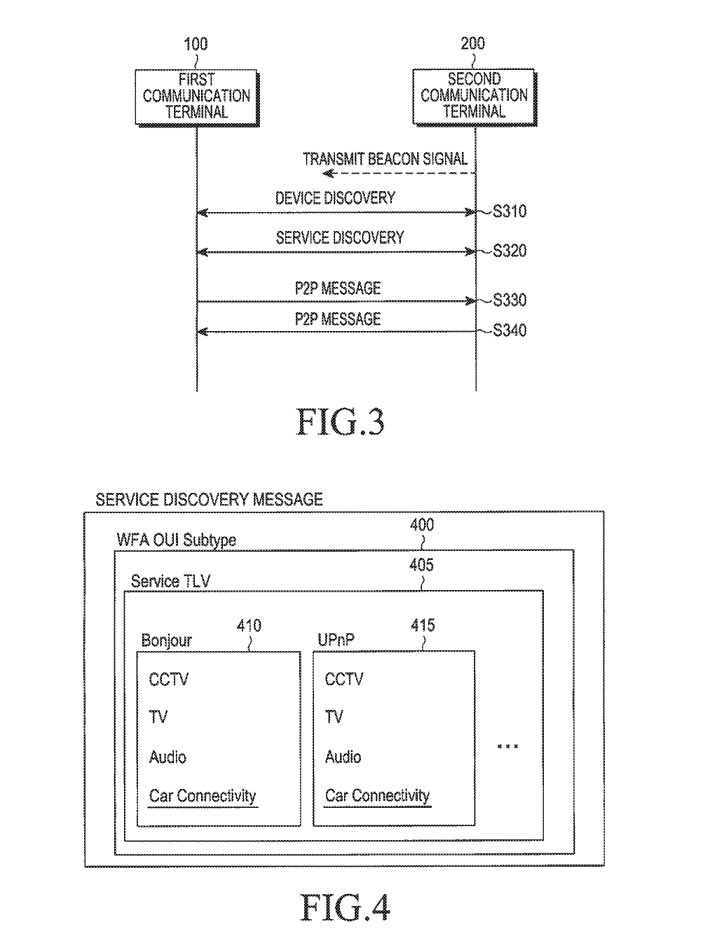

FIG. 3 is a signal flow diagram corresponding to a communication process between a first communication terminal and a second communication terminal according to an embodiment of the present invention. In this embodiment of the present invention, the first communication terminal 100 and the second communication terminal 200 communicate with each other using a WFD technology corresponding to a wireless LAN technology. However, the present invention is not limited to this configuration and may use other wireless communication protocols.

When a connectionless messaging application is executed, the first communication terminal 100 activates a wireless LAN function of the communication unit 140, and performs the steps in FIG. 3 using the controller 150 for controlling the other elements.

In step S310, the first communication terminal 100 performs a device discovery procedure for discovering devices around the first communication terminal 100, and thereby finds the second communication terminal 200 which transmits a beacon signal. The beacon signal (or the message) includes a device ID corresponding to unique identifier information of the second communication terminal 200.

In step S320, the first communication terminal 100 performs a service discovery procedure for discovering services capable of being supported, and thereby identifies whether a service intended to be used by the first communication terminal 100 may be supported by the second communication terminal 200. When it is necessary to set up a connection between the first communication terminal 100 and the second communication terminal 200, a subsequent procedure for setting up a connection between the first communication terminal 100 and the second communication terminal 200 may be performed on a service supported by both communication terminals.

Such a service is used after the connection between the first communication terminal 100 and the second communication terminal 200 is established. The connectionless messaging according to an embodiment of the present invention is performed before the connection between the first communication terminal 100 and the second communication terminal 200 is established. Accordingly, the first communication terminal 100 may optionally transmit a first service discovery message (or a service discovery request message), which designates a service, to the second communication terminal 200. Specifically, the first communication terminal 100 may transmit a first service discovery message, which designates a preset (namely, default) service (for example, a service method (protocol) and a service type), to the second communication terminal 200. Also, the first communication terminal 100 receives a second service discovery message (or a service discovery response message) responding to the first service discovery message, from the second communication terminal 200. The second service discovery message specifies services supported by the second communication terminal 200.

FIG. 4 is a view corresponding to a service discovery message. The service discovery message has the format of a Generic Advertisement Service (GAS) message defined in IEEE802.11u, and includes a Wi-Fi Alliance (WFA) Organizational Unique Identifier (OUI) subtype 400 in order to represent that the service discovery message has the type of a message defined by WFA. The WFA OUI subtype 400 includes a service Type-Length-Value (TLV) field 405. The service TLV field 405 allows various service methods (or protocols). FIG. 4 shows an example in which the service TLV field allows service methods including a Bonjour 410, a UPnP 415, etc. Each service method allows various service types. FIG. 4 shows an example in which each service method allows service types such as, for example, CCTV, TV, audio, and car connectivity.

In step S330, the first communication terminal 100 transmits a first P2P message, including contents (or information) indicating that the first user has input, to the second communication terminal 200. For example, the contents may be sentences, for example, “Please be careful of accidents ahead,” “I am passing you. Please be careful,” and “The rear tire of the 7677 vehicle seems to be flat.” Examples of the user input as described above may include direct input, the selection and input of a preset sentence, etc.

In step S340, the second communication terminal 200 transmits a second P2P message, including contents indicating that a second user has input, to the first communication terminal 100 in response to the first P2P message. For example, the contents may be a sentence such as “Thank you.”

A format of the P2P message is shown in Table 1 below.

TABLE 1

| | Size | Value | |
|---|---|---|---|
| Field | (octets) | (hexadecimal) | Description |
| Category | 1 | 0x04 | IEEE 802.11 public action usage |
| Action | 1 | 0x09 | IEEE 802.11 vendor specific usage |
| field | | | |
| OUI | 3 | 00 50 F2 | WFA specific OUI |
| OUI type | 1 | 0x09 | Identifying the type or version of |
| | | (to be assigned) | action frame. Setting to 09 |
| | | | indicates WFA P2P v1.0. |
| OUI | 1 | | Identifying the type of P2P public |
| subtype | | | action frame. The specific value |
| | | | is defined in Table 2. |
| Dialog | 1 | | Set to nonzero value to identify the |
| token | | | request/response transaction. |
| Elements | variable | | Including P2P information element |
| | | | (IE) or any information elements |
| | | | defined in IEEE Std 802. 11-2007 |
| | | | [1]. |

The OUI subtype shown in Table 1 has one of the values shown in Table 2 below, and a P2P transmission message is distinguished from a P2P response message by using such a value. Also, the elements field shown in Table 1 is configured as shown in Table 3 below.

TABLE 2

| Type | Note |
|---|---|
| 0 | GO negotiation request |
| 1 | GO negotiation response |
| 2 | GO negotiation confirmation |
| 3 | P2P invitation request |
| 4 | P2P invitation response |
| 5 | Device discoverability request |
| 6 | Device discoverability response |
| 7 | Provision discovery request |
| 8 | Provision discovery response |
| 9 | P2P message send |
| 10 | P2P message response |
| 11~255 | Reserved |

TABLE 3

| Sub-element | Sub-element ID | Note |
|---|---|---|
| P2P message | 17 | P2P message sub-element |
| P2P message timeout | 18 | Time period waiting for P2P |
| | | response message |
| P2P device ID | 3 | Identifier of P2P message |
| | | transmission apparatus |

Configurations of the sub-elements shown in Table 3 are shown in Tables 4 to 6 below. Table 4 below shows a P2P message sub-element. Table 5 below shows a P2P message timeout sub-element. Table 6 below shows a P2P device ID sub-element.

TABLE 4

| | Size | | |
|---|---|---|---|
| Field | (octets) | Value | Description |
| Sub-element | 1 | 17 | Identifying the type of P2P message |
| ID | | | sub-element. |
| Length | 1 | 2 | Length of the following fields in the |
| | | | sub-element |
| Message | Variable | | Message contents to send |

In regard to a P2P transmission message and a P2P response message, contents (namely, user input data) that a user intends to transmit are entered into the P2P message sub-element shown in Table 4.

TABLE 5

| | Size | | |
|---|---|---|---|
| Field | (octets) | Value | Description |
| Sub-element | 1 | 18 | Identifying the type of P2P message |
| ID | | | timeout sub-element. |
| Length | 1 | 2 | Length of the following fields in the |
| | | | sub-element |
| Time | 1 | 0~255 | Time to wait until it receives reply to |
| | | | sent message in units of 1 second. |

The P2P message timeout sub-element shown in Table 5 represents a time period waiting for a P2P response message after the transmission of a P2P message, on a per second basis. For example, after the first communication terminal 100 transmits the P2P message to the second communication terminal 200, it does not release the wireless LAN function of the communication unit 140 during a timeout period, and waits for the P2P response message from the second communication terminal 200.

TABLE 6

| | Size | | |
|---|---|---|---|
| Field | (octets) | Value | Description |
| Sub-element | 1 | 3 | Identifying the type of P2P sub-element. |
| ID | | | |
| Length | 1 | 6 | Length of the following fields in the sub- |
| | | | element |
| Time | 6 | — | An identifier used to uniquely reference |
| | | | a P2P Device. |

The P2P device ID sub-element shown in Table 6 represents unique identifier information of a device which transmits a P2P message. Also, the identifier information may be identical to a device ID included in a beacon signal.

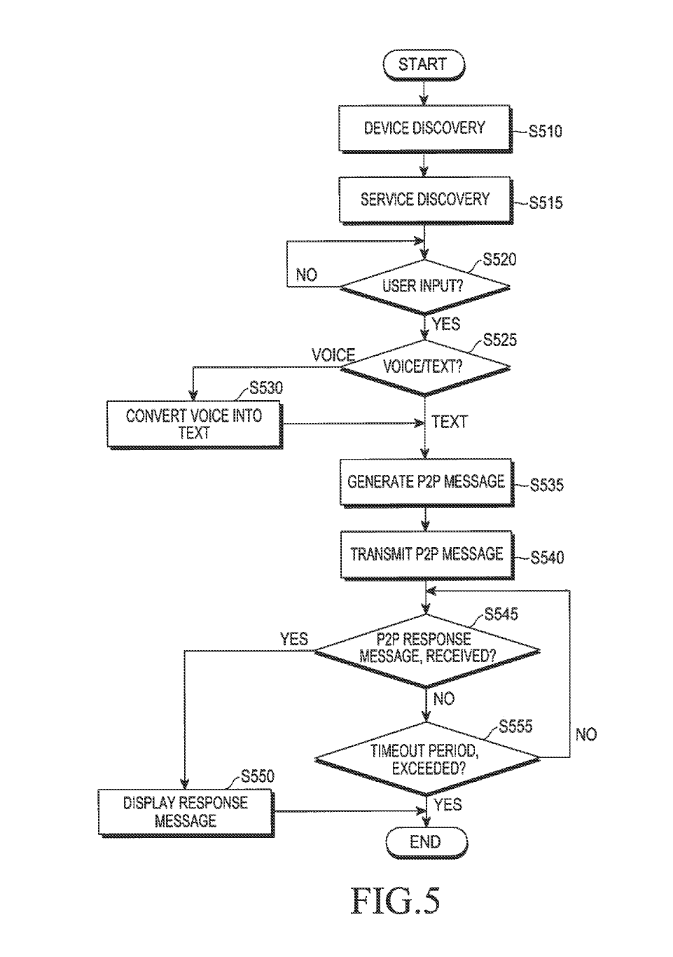

FIG. 5 is a flowchart corresponding to a method for connectionless messaging by a first communication terminal according to an embodiment of the present invention. Hereinafter, the term “user” refers to the first user of the first communication terminal 100.

When a connectionless messaging application is executed automatically or in response to the user's selection, the first communication terminal 100 performs the steps shown in FIG. 5 using the controller 150 for controlling the other elements.

In step S510, the first communication terminal 100 performs a device discovery procedure for discovering devices around the first communication terminal 100, and thereby finds the second communication terminal 200 which transmits a beacon signal.

In step S515, the first communication terminal 100 performs a service discovery procedure for discovering services capable of being supported, and thereby identifies whether a service intended to be used by the first communication terminal 100 may be supported by the second communication terminal 200.

In step S520, the first communication terminal 100 periodically or aperiodically identifies whether there exists user input (for example, a voice command, keypad input, or touch input) for writing a message. When the first communication terminal 100 receives user input data, it performs step S525. When the first communication terminal 100 fails to receive the user input data, the first communication terminal 100 repeatedly performs step S520 until it receives the user input data. Alternatively, if the first communication terminal 100 fails to receive the user input data during a predetermined time period, it may release the wireless LAN function of the communication unit 140 in order to prevent resource consumption.

In step S525, the first communication terminal 100 determines whether the user input data is voice data or text data. When the user input data is voice data, the first communication terminal 100 performs step S530. When the user input data is text data, the first communication terminal 100 performs step S535.

In step S530, the first communication terminal 100 converts the voice data of the user into text data.

In step S535, the first communication terminal 100 generates a P2P message which has the format shown in Table 1 and includes the text data. Step S535 may be performed through the transmission button 106 or a voice command, or based on an elapsed time period from a time point of the last user input.

In step S540, the first communication terminal 100 transmits the generated P2P message to the second communication terminal 200.

In step S545, the first communication terminal 100 periodically or aperiodically identifies whether it receives a P2P response message from the second communication terminal 200. When the first communication terminal 100 receives the P2P response message, it performs step S550. If the first communication terminal 100 fails to receive the P2P response message, it performs step S555.

In step S550, the first communication terminal 100 displays, to the user, text data (namely, user input data of the second communication terminal 200) included in the P2P response message received from the second communication terminal 200.

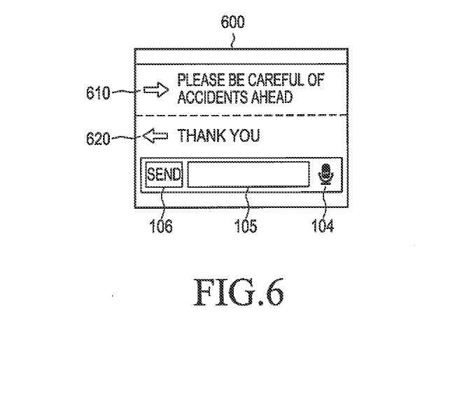

FIG. 6 is a view illustrating a screen of a first communication terminal. The first communication terminal 100 displays, to the user, text data 620 (namely, e.g., “Thank you”) included in the P2P response message received from the second communication terminal 200. On a screen 600 of the first communication terminal 100, text data 610 (e.g., “Please be careful of accidents ahead.”) of the P2P message that the first communication terminal 100 has transmitted to the second communication terminal 200 may also be displayed together with the text data 620.

In step S555, the first communication terminal 100 determines whether an elapsed time period from a time point of transmitting the P2P message to a present time exceeds a timeout period designated by the P2P message timeout sub-element. When a result of the determination in step S555 shows that the elapsed time period exceeds the timeout period, the first communication terminal 100 completes the method for connectionless messaging. When the result of the determination in step S555 shows that the elapsed time period is less than or equal to the timeout period, the first communication terminal 100 repeats step S545.

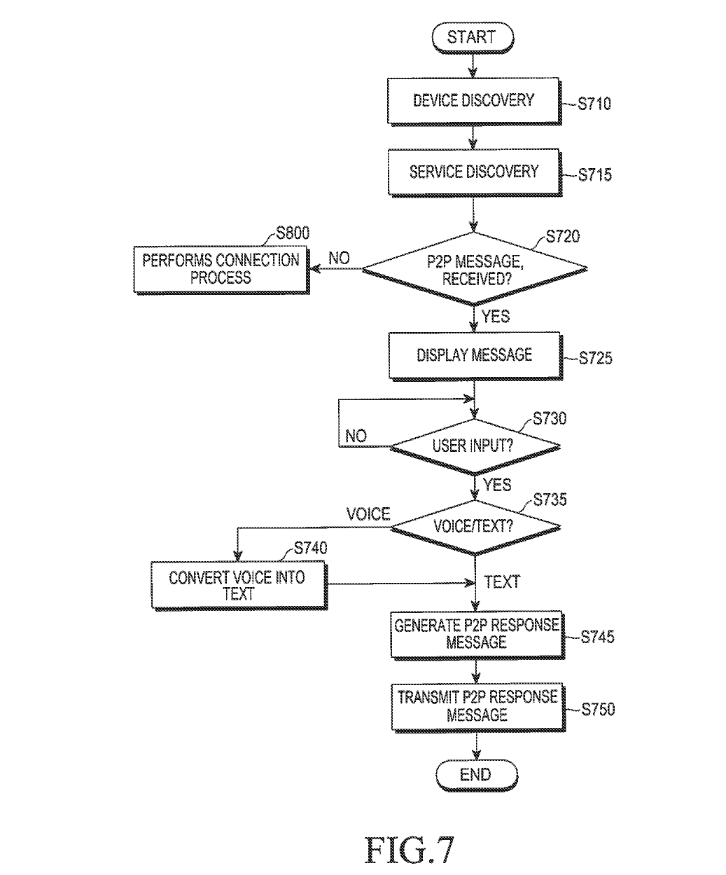

FIG. 7 is a flowchart corresponding to a method for connectionless messaging by a second communication terminal according to an embodiment of the present invention. In this embodiment, the method for connectionless messaging is described as a method performed by the second communication terminal 200. However, a method identical to the method for connectionless messaging may be performed by the first communication terminal 100. Hereinafter, the term “user” refers to the second user of the second communication terminal 200.

The second communication terminal 200 which may have a configuration identical to or different from that of the first communication terminal 100, executes a connectionless messaging application according to the user's selection or a device discovery request from the first communication terminal 100, or automatically, and performs the steps shown in FIG. 7 using a controller for controlling the other elements.

In step S710, the second communication terminal 200 performs a device discovery procedure between itself and the first communication terminal 100, which sends a request for the device discovery procedure to the second communication terminal 200, and thereby identifies the first communication terminal 100.

In step S715, the second communication terminal 200 performs a service discovery procedure between itself and the first communication terminal 100, and thereby provides the first communication terminal 100 with the identification of whether the second communication terminal 200 supports a service intended to be used by the first communication terminal 100. Also, the second communication terminal 200 may identify whether the first communication terminal 100 supports a service intended to be used by the second communication terminal 200.

In step S720, the second communication terminal 200 receives a message from the first communication terminal 100, and identifies whether the received message is a P2P message. When the received message is a P2P message, the second communication terminal 200 performs step S725. When the received message is not a P2P message, the second communication terminal 200 performs step S800. For example, when an OUI type field of the received message defined in Table 1 has a value of 9 (P2P message send), as defined in Table 2, the second communication terminal 200 may determine that the received message is a P2P message.

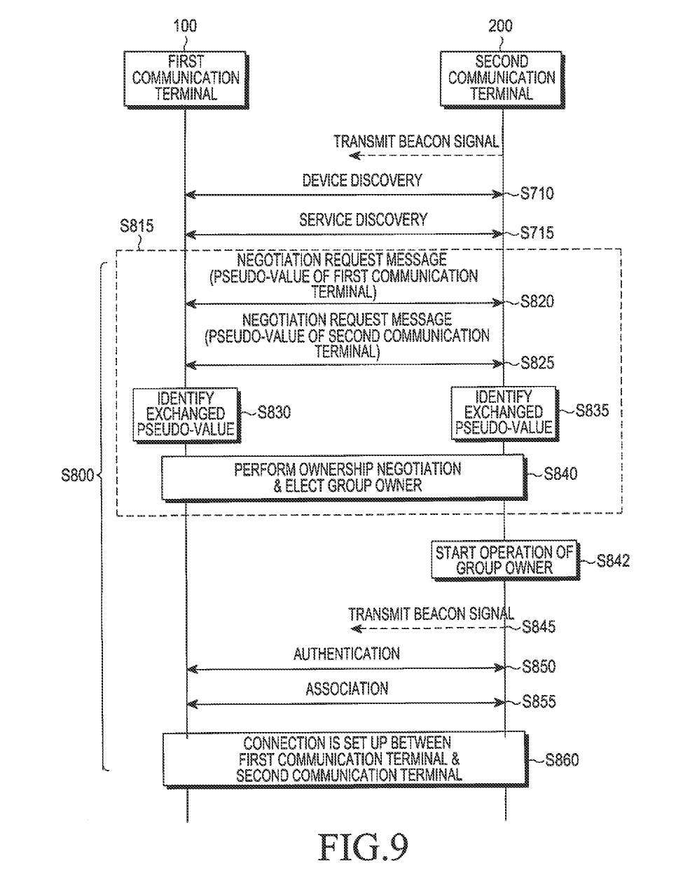

In step S800, the second communication terminal 200 performs a connection process as described below with reference to FIG. 9. The received message becomes a negotiation request message in the connection process as described below.

In step S725, the second communication terminal 200 displays, to the user, text data (namely, user input data of the first communication terminal 100) included in the P2P message received from the first communication terminal 100.

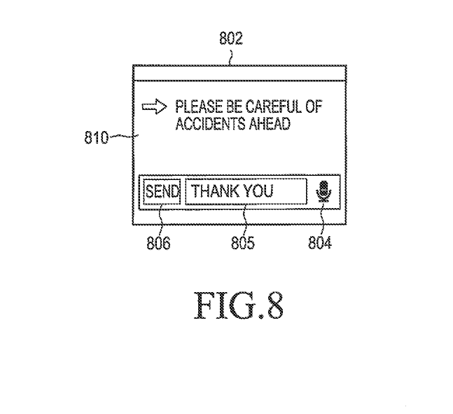

FIG. 8 is a view illustrating a screen 802 of the second communication terminal 200. The second communication terminal 200 displays, to the user, text data (e.g., the contents “Please be careful of accidents ahead.”) included in the P2P message received from the first communication terminal 100.

In step S730, the second communication terminal 200 periodically or aperiodically identifies whether there exists user input (for example, a voice command, keypad input, or touch input) for writing a message. When the second communication terminal 200 receives the user input, it performs step S735. When the second communication terminal 200 fails to receive the user input, the second communication terminal 200 repeatedly performs step S730 until it receives the user input. If the second communication terminal 200 fails to receive the user input during a predetermined time period, it may release a wireless LAN function of a communication unit in order to prevent resource consumption.

In step S735, the second communication terminal 200 determines whether the user input data is voice data or text data. When the user input data is voice data, the second communication terminal 200 performs step S740. When the user input data is text data, the second communication terminal 200 performs step S745.

In step S740, the second communication terminal 200 converts the voice data of the user into text data. FIG. 8 shows an example in which the user of the second communication terminal 200 speaks “Thank you,” and a voice recognition application 804 converts the voice data of the user into text data and displays the converted text data in a message input window 805. The message may be transmitted through the separate transmission button 106 or a voice command, or based on an elapsed time period from the last input time point. Also, on the screen 802, user input data 810 (e.g., “Please be careful of accidents ahead.”) of the first communication terminal 100, which is included in the received P2P message, may be displayed.

In step S745, the second communication terminal 200 generates a P2P response message which has the format shown in Table 1 and includes the text data. In the P2P response message, an OUI type field defined in Table 1 may have a value of 10 (P2P message response), as defined in Table 2. Step S745 may be performed through a transmission button 806 or a voice command, or based on an elapsed time period from a time point of the last user input.

In step S750, the second communication terminal 200 transmits the generated P2P response message to the first communication terminal 100.

FIG. 9 is a signal flow diagram corresponding to a connection process between a first communication terminal and a second communication terminal. Step S800 performed after steps S710 and S715 includes subsequent sub-steps. A group owner negotiation procedure in step S815 is as follows.

In step S820, the first communication terminal 100 determines a pseudo-value of a status of a group owner in response to a discovered service. To this end, the first communication terminal 100 may determine the pseudo-value with reference to a pseudo-value mapping table for each service. Then, the first communication terminal 100 generates a group owner negotiation request message (hereinafter, referred to as a “negotiation request message”) including the determined pseudo-value of the first communication terminal 100. Next, the first communication terminal 100 delivers the negotiation request message including the pseudo-value of the first communication terminal 100, to the second communication terminal 200.

In step S825, the second communication terminal 200 transmits a group owner negotiation response message (hereinafter, referred to as a “negotiation response message”) including a pseudo-value of the second communication terminal 200, to the first communication terminal 100 in response to the negotiation request message. In contrast, when the second communication terminal 200 first transmits a negotiation request message including a pseudo-value of the second communication terminal 200 to the first communication terminal 100, the first communication terminal 100 may transmit a negotiation response message including a determined pseudo-value of the first communication terminal 100, to the second communication terminal 200. As described above, a subject that transmits a negotiation request message does not have to be the first communication terminal 100. The first communication terminal 100 may exchange negotiation messages with the second communication terminal 200 in order to identify a pseudo-value of a counterpart.

A format of the negotiation message is shown in Table 1. In the negotiation request message, an OUI type field defined in Table 1 has a value of 0 (GO negotiation request), as defined in Table 2. In the negotiation response message, an OUI type field defined in Table 1 has a value of 1 (GO negotiation response), as defined in Table 2.

The negotiation request message includes fields shown in Table 7 below, and the negotiation response message includes fields shown in Table 8 below.

TABLE 7

| | Attribute | |
|---|---|---|
| Attribute | ID | Note |
| Status | 0 | The status attribute shall only be present in |
| | | the P2P IE if the status code being signaled |
| | | is “Rejected by User.” |
| P2P capability | 2 | The P2P capability attribute shall be |
| | | present in the P2P IE. |
| Group owner | 4 | The group owner intent attribute shall be |
| intent | | present in the P2P IE. |
| Configuration | 5 | The configuration timeout attribute shall be |
| timeout | | present in the P2P IE. |
| Listen channel | 6 | The listen channel attribute shall be present |
| | | in the P2P IE. |
| Extended listen | 8 | The extended listen timing attribute may be |
| timing | | present in the P2P IE to advertise listen |
| | | state availability of the P2P device sending |
| | | the GO negotiation request. |
| Intended P2P | 9 | The intended P2P interface address |
| interface | | attribute shall be present in the P2P IE. |
| address | | |
| Channel list | 11 | The channel list attribute shall be present in |
| | | the P2P IE. |
| P2P device info | 13 | The P2P device information attribute shall |
| | | be present in the P2P IE. |
| Operating | 17 | The operating channel attribute shall be |
| channel | | present in the P2P IE. |

In Table 7, a pseudo-value determined according to the type of service is set to a group owner intent field.

TABLE 8

| | Attribute | |
|---|---|---|
| Attribute | ID | Note |
| Status | 0 | The status attribute shall be present in the |
| | | P2P IE. |
| P2P capability | 2 | The P2P capability attribute shall be |
| | | present in the P2P IE. |
| Group owner | 4 | The group owner intent attribute shall be |
| intent | | present in the P2P IE. |
| Configuration | 5 | The configuration timeout attribute shall be |
| timeout | | present in the P2P IE. |
| Operating | 17 | The operating channel attribute shall be |
| channel | | present in the P2P IE. |
| Intended P2P | 9 | The intended P2P interface address |
| interface | | attribute shall be present in the P2P IE. |
| address | | |
| Channel list | 11 | The channel list attribute shall be present in |
| | | the P2P IE. |
| P2P device info | 13 | The P2P device information attribute shall |
| | | be present in the P2P IE. |

As illustrated in Tables 7 and 8, a pseudo-value determined according to the type of service is set to a group owner intent field. Each pseudo-value may be set to a basically-set default value.

In step S830, the first communication terminal 100 identifies the pseudo-value included in the negotiation response message.

In step S835, the second communication terminal 200 identifies the pseudo-value included in the negotiation request message.

In step S840, the first communication terminal 100 and the second communication terminal 200 perform ownership negotiation and elect a group owner. Specifically, the first communication terminal 100 compares the pseudo-value thereof with that of the second communication terminal 200, and selects a communication terminal having a higher pseudo-value as a group owner. In this embodiment of the present invention, a case is described as an example where the second communication terminal 200 has a higher pseudo-value than that of the first communication terminal 100.

In step S842, the second communication terminal 200 starts the operation of the group owner. Specifically, in order to perform the operation of the group owner, the second communication terminal 200 performs an operation which is not the operation of a client but is identical to that of an Access Point (AP).

In step S845, the second communication terminal 200 transmits a beacon signal.

In step S850, the second communication terminal 200 performs an authentication procedure between itself and the first communication terminal 100.

In step S855, the second communication terminal 200 performs an association between itself and the first communication terminal 100. In step S860, a connection is set up between the first communication terminal 100 and the second communication terminal 200.

In the messaging methods according to embodiments of the present invention, a connection setup is not separately required in contrast to the prior art, and a scheme for connectionless messaging which is different from a scheme for exchanging messages between previously-registered users is provided. Accordingly, the messaging methods according to embodiments of the present invention can be used even in a vehicle environment.

It will be appreciated that the embodiments of the present invention may be implemented in the form of hardware, software, or a combination of hardware and software. Any such software may be stored in a volatile or non-volatile storage device such as a ROM (Read-Only Memory), or in a memory such as a RAM (Random Access Memory), a memory chip, a memory device or a memory integrated circuit, or in a storage medium, such as a CD (Compact Disc), a DVD (Digital Versatile Disc), a magnetic disk or a magnetic tape, which is optically or magnetically recordable and simultaneously, is readable by a machine, regardless of whether the software can be deleted or rewritten. It will be appreciated that a memory is an example of a storage medium readable by a machine (for example, a computer) suitable for storing a program or programs including instructions for implementing the embodiments of the present invention. Accordingly, the present invention includes a program including a code for implementing a method claimed in any claim of this specification, and a machine-readable storage medium for storing this program. Also, this program may be electronically conveyed via any medium such as a communication signal transmitted through a wired or wireless connection, and the present invention suitably includes equivalents of this program.

While the invention has been shown and described with reference to certain embodiments thereof, it will be understood by those skilled in the art that various changes in form and details may be made therein without departing from the spirit and scope of the present invention as defined by the appended claims and equivalents thereof.

What is claimed is:

1. A method for connectionless messaging between a first communication terminal and a second communication terminal, comprising:
discovering a second communication terminal located in proximity to the first communication terminal;
receiving first user input data;
generating a message including the first user input data; and
transmitting the generated message to the second communication terminal without a connection between the first communication terminal and the second communication terminal.

2. The method as claimed in claim 1, further comprising discovering a service supported by the second communication terminal.

3. The method as claimed in claim 1, further comprising:
identifying whether the first user input data is voice data; and
converting the first user input data into text data when the first user input data is the voice data.

4. The method as claimed in claim 1, further comprising:
receiving a response message to the transmitted message from the second communication terminal; and
reporting second user input data of the second communication terminal, which is included in the response message, to a user.

5. The method as claimed in claim 1, further comprising:
identifying whether a response message to the transmitted message is received from the second communication terminal during a predetermined timeout period; and
deactivating a communication unit of the first communication terminal when the response message to the transmitted message is not received from the second communication terminal during the predetermined timeout period.

6. A method for connectionless messaging between a first communication terminal and a second communication terminal, comprising:
discovering a second communication terminal located in proximity to the first communication terminal;
receiving a message from the second communication terminal without a connection between the first communication terminal and the second communication terminal;
identifying whether the received message is a peer-to-peer (P2P) message including first user input data of the second communication terminal; and
reporting the first user input data of the second communication terminal to a user of the first communication terminal when the received message is the P2P message.

7. The method as claimed in claim 6, further comprising:
receiving second user input data;
generating a response message including the second user input data; and
transmitting the response message to the second communication terminal without a connection between the first communication terminal and the second communication terminal.

8. The method as claimed in claim 6, further comprising discovering a service supported by the second communication terminal.

9. The method as claimed in claim 7, further comprising:
identifying whether the second user input data is voice data; and
converting the second user input data into text data when the second user input data is the voice data.

10. A non-transitory machine-readable storage medium for recording a program for executing a method for connectionless messaging, the method comprising:
discovering a second communication terminal located in proximity to the first communication terminal;
receiving first user input data;
generating a message including the first user input data; and
transmitting the generated message to the second communication terminal without a connection between the first communication terminal and the second communication terminal.

11. The machine-readable storage medium as claimed in claim 10, wherein the method further comprises:
discovering a service supported by the second communication terminal.

12. The machine-readable storage medium as claimed in claim 10, wherein the method further comprises:
identifying whether the first user input data is voice data; and
converting the first user input data into text data when the first user input data is the voice data.

13. The machine-readable storage medium as claimed in claim 10, wherein the method further comprises:
receiving a response message to the transmitted message from the second communication terminal; and
reporting second user input data of the second communication terminal, which is included in the response message, to a user.

14. The machine-readable storage medium as claimed in claim 10, wherein the method further comprises:
identifying whether a response message to the transmitted message is received from the second communication terminal during a predetermined timeout period; and
deactivating a communication unit of the first communication terminal when the response message to the transmitted message is not received from the second communication terminal during the predetermined timeout period.

15. A communication terminal including a non-transitory machine-readable storage medium for recording a program for executing a method for connectionless messaging, the method comprising:
discovering a second communication terminal located in proximity to the first communication terminal;
receiving first user input data;
generating a message including the first user input data; and
transmitting the generated message to the second communication terminal without a connection between the first communication terminal and the second communication terminal.
